(19) United States
(12) Patent Application Publication
(10) Pub. No.: US 2016/0148483 A1
(43) Pub. Date: May 26, 2016

(54) DRIVEWAY GATE MONITORING SYSTEM

(71) Applicant: MICHAEL ALLEN ROBB, BEDFORD, TX (US)

(72) Inventor: MICHAEL ALLEN ROBB, BEDFORD, TX (US)

(21) Appl. No.: 14/885,887

(22) Filed: Oct. 16, 2015

Related U.S. Application Data
(60) Provisional application No. 62/085,143, filed on Nov. 26, 2014.

(51) Int. Cl. G08B 21/18

(52) U.S. Cl. CPC G08B 21/18

(57) ABSTRACT

A system provides the open or closed status of a gate so that the user can monitor this status without having to physically go outside to see the gate. The system includes a sensor/emitter combination coupled to a gate. A wireless transmitter sends a signal indicating the open/close status of the gate to a remote module with status indicators showing the status of the gate.

### CROSS-REFERENCE TO RELATED APPLICATIONS

This application claims benefit under 35 U.S.C. §119(e) of U.S. Provisional Application having Ser. No. 62085143 filed Nov. 26, 2014, which is hereby incorporated by reference herein in its entirety.

### BACKGROUND

The embodiments herein relate generally to systems for monitoring gates and more particularly, driveway gates.

Conventional driveway gates have mechanical lock and key systems that are stand alone. Typical gate systems may require manual opening and closing of the gate. Automated gates have driver systems to open and close the gate. In either manual or automated types of systems, a user may need to personally visually inspect the gate to determine whether the gate is closed or open. The gate may be distant from a home's interior and thus requires a user to leave the home to go outside to inspect the gate status. For parents with small children that play outside or pet owners, the gate status presents a security concern that requires constant monitoring.

Embodiments of the present invention provide a solution to determining whether a driveway gate is open or closed.

### SUMMARY

A system for providing an open or closed status of a gate comprises a sensor attached to either the driveway gate or a post configured to receive the gate. An emitter may be attached to either the gate or the post configured to receive the gate. A master module may include a circuit configured to detect the open or closed status of the gate. A wireless transmitter in the master module may emit a signal representing the open or closed status of the gate based on the sensor being displaced from the emitter. A remote slave module includes a status indicator indicating the open or closed status of the gate based on the signal received from the wireless transmitter.

### BRIEF DESCRIPTION OF THE FIGURES

The detailed description of some embodiments of the invention is made below with reference to the accompanying figures, wherein like numerals represent corresponding parts of the figures.

FIG. 1 is a perspective front view of a system for monitoring the status of a gate according to an embodiment of the subject technology.

FIG. 2 is a partial view of a first sensor in the system of FIG. 1.

FIG. 3 is a partial view of a second sensor in the system of FIG. 1.

FIG. 4 is the system of FIG. 1 with the gate in an open state.

FIG. 5 is a partial view of a first sensor in the system of FIG. 4.

FIG. 6 is an open view of a master module with a wireless transmitter for detecting the status of the gate of FIG. 1.

FIG. 7 is a series of front views of the master module of FIG. 1 transmitting wireless signals to slave modules according to an embodiment of the subject technology.

FIG. 8 shows an electrical schematic for detecting the status of a gate according to embodiments of the subject technology.

### DETAILED DESCRIPTION OF CERTAIN EMBODIMENTS

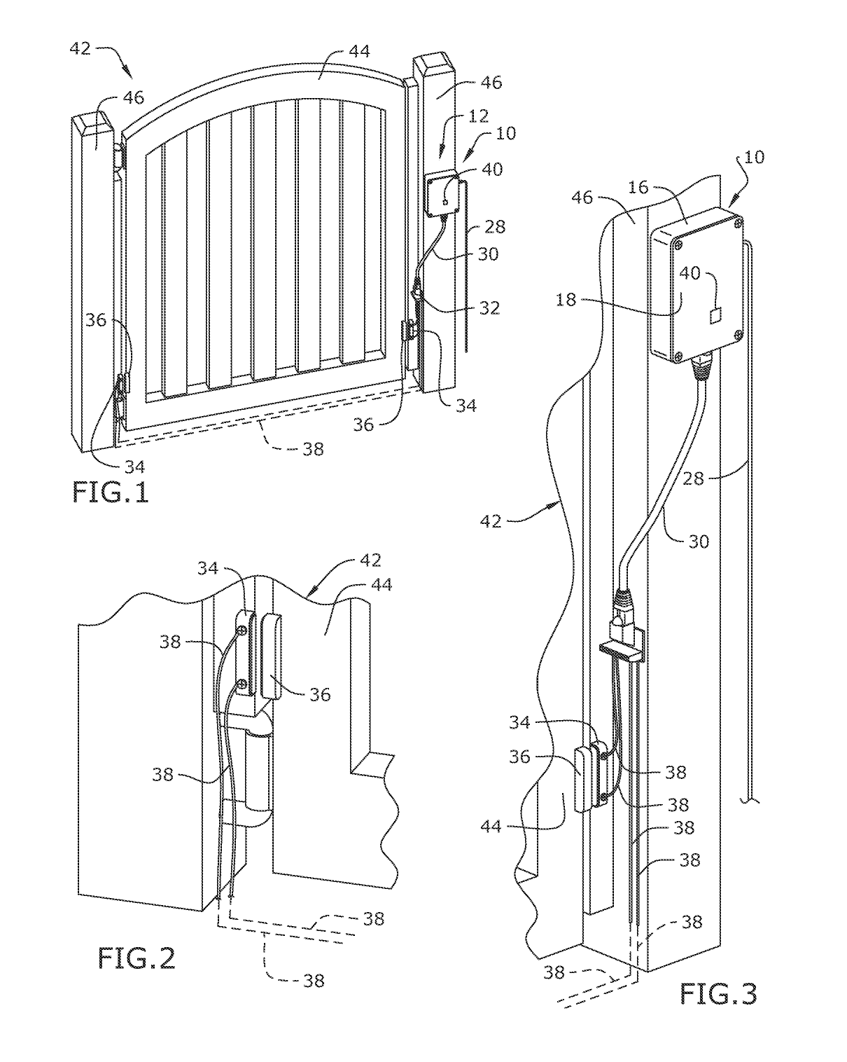

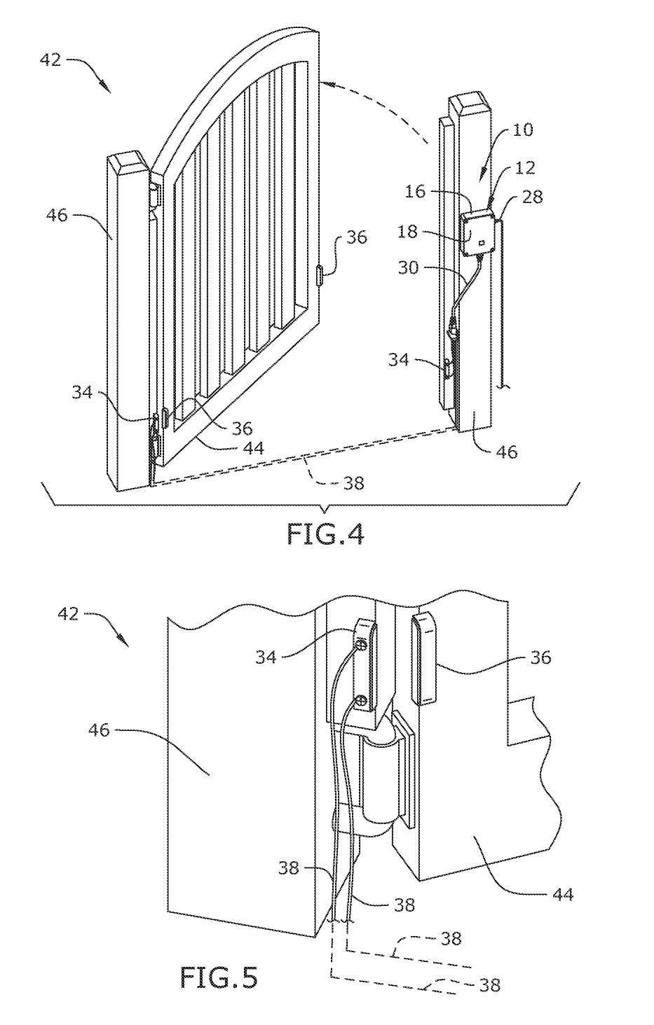

Referring to FIG. 1-5, broadly, embodiments of the disclosed invention provide a system that provides the open or closed status of a gate 42 (for example a driveway gate) so that the user can monitor this open/closed status without having to physically go outside to see the gate 42. The gate 42 may include a frame 44 coupled to posts 46. The system includes an emitter/sensor (34;36) combination coupled to the gate 42. The emitter 34 may be attached to respective gate posts 46 and the sensor may be attached to the gate frame 44. The sensor 36 may be on the movable frame of the gate while the emitter 34 may be on the post 46 that receives the gate 42, or vice versa. In an exemplary embodiment, the emitter/sensor (34;36) combination may be an electro-magnetic sensor arrangement that when the two elements are sufficiently within proximity of each other, a magnetic field closes a circuit detected within a master module 10 (housed within a box 16) with a status indicator window 40 (for example, containing a light emitting diode (LED) that lights up to represent the open/closed status of the gate 42) proximate the gate 42. In response to the gate 42 opening, the sensor 36 is displaced from the emitter 34 so that the magnetic field between the two elements is weakened opening the circuit which is detected at the module 10 (via cable 30). As shown, the emitter/sensor (34;36) combination may be hardwired to the master module 10 by wires 38. In the embodiment shown, there may be first and second emitter/sensor (34;36) combinations for both ends of the gate 42. A power cord 28 may provide power to the module 10 as is known in the art.

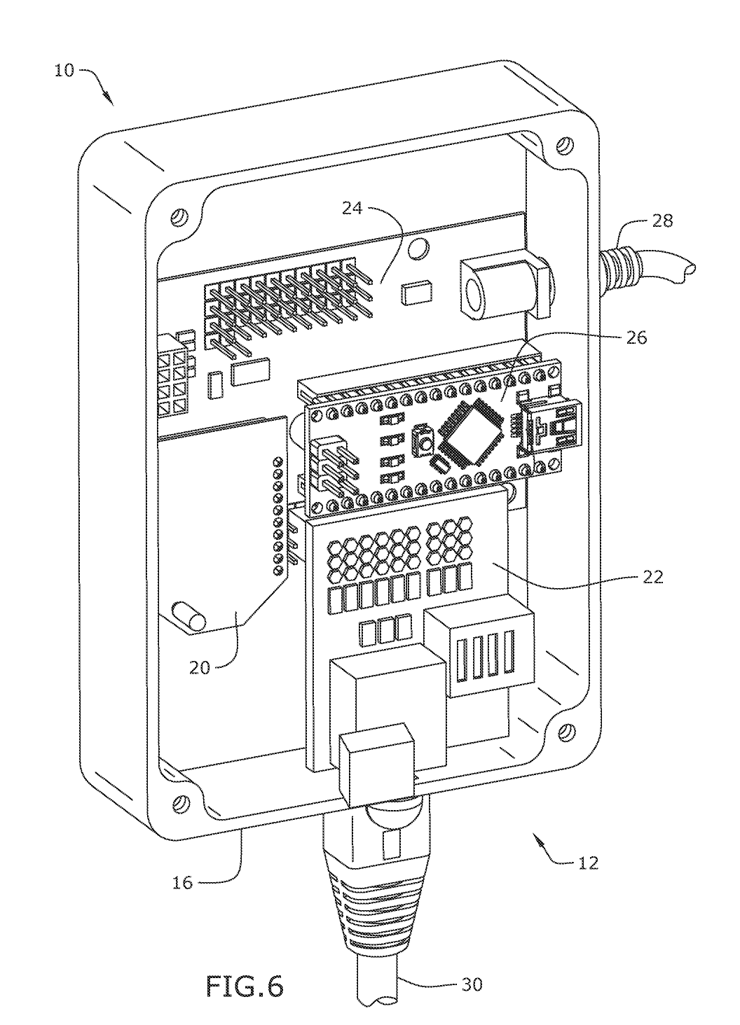

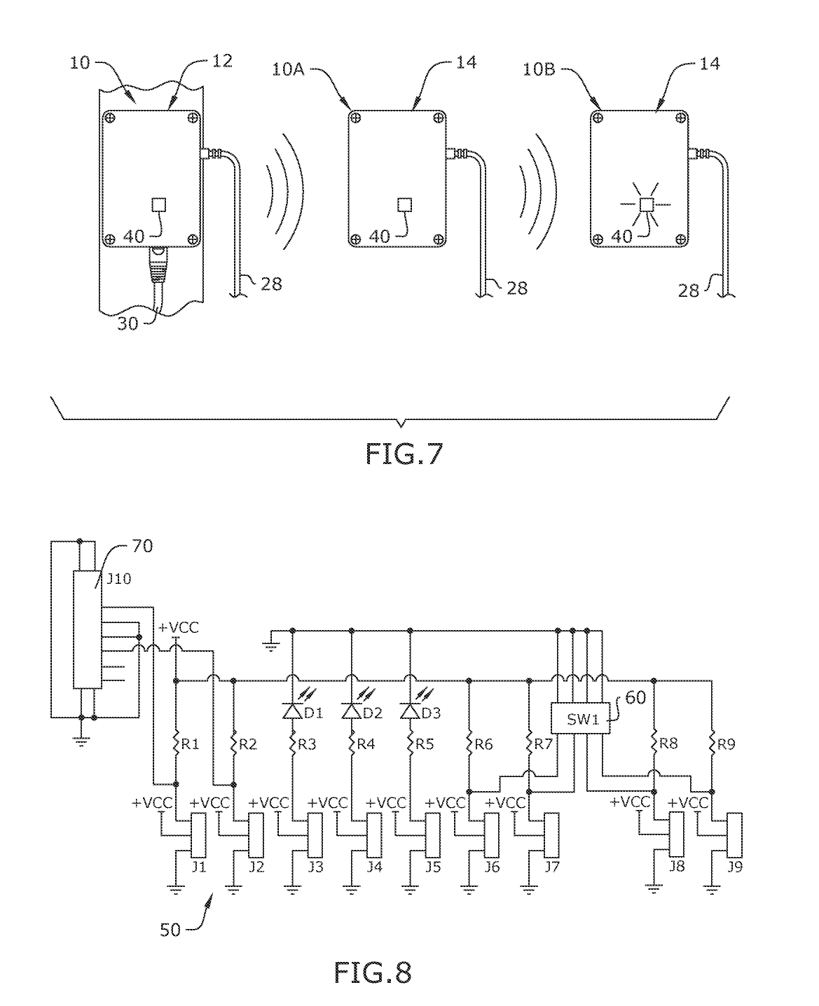

Referring now to FIGS. 6-8, in an exemplary embodiment, the master module 10 may be in wireless communication with one or more slave modules (10A; 10B) located within a residence (not shown) so that persons inside the residence may view to the module(s) (10A; 10B) to determine whether the gate 42 is open or closed. The master module 10 may include a wireless transmitter 20 (for example, an XBee® type radio module) coupled to a microcontroller 26 and PCB 22 configured to detect the open/closed status of the gate 42. In some embodiments, an I0 shield 24 may be included and functions as known in the art. The module(s) (10A; 10B) may receive the indication of open/closed status from the master module 10, the status of which is shown status on respective slave modules 10A and 10B indicators 40. A person in the residence may look to the status indicator 40 and visually confirm whether the gate 42 is open or closed from the comfort of their home. FIG. 8 shows an exemplary layout for the printed circuit board 22 used in the modules 10, 10A, and 10B according to an exemplary embodiment of the present invention. A row of 3 pin switches 50 represent for example, the number of modules 10, 10A, 10B, etc. that may be connected in the system. Control of the open/closed circuit status may be performed by a 4 position DIP switch 60 whose signal may be provided to an RJ45 connector 70 for communicating the status among modules 10, 10A, 10B, etc.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above. For example, while the above description included the use of magnet sensors, it will be understood that other sensor emitter combinations may be used. For example, an electro-optical combination using a light source and a photo-detector may provide the signal that indicates whether the gate is open or closed in the event a beam from the light source is broken or is out of range from the photo-detector.

What is claimed is:

1. A system for providing an open or closed status of a gate, comprising:
a sensor attached to either the driveway gate or a post configured to receive the gate;
an emitter attached to either the gate or the post configured to receive the gate;
a master module including a circuit configured to detect the open or closed status of the gate;
a wireless transmitter in the master module configured to emit a signal representing the open or closed status of the gate based on the sensor being displaced from the emitter; and
a remote slave module including a status indicator indicating the open or closed status of the gate based on the signal received from the wireless transmitter.

2. The system of claim 1, wherein the status indicator is a light emitting diode (LED).

3. The system of claim 1, wherein the remote slave module is located within a residence.

4. The system of claim 1, wherein the sensor and emitter are an electro-magnetic arrangement.

5. The system of claim 1, wherein the gate is a driveway gate.
